(19) United States
(12) Patent Application Publication
(10) Pub. No.: US 2006/0173858 A1
(43) Pub. Date: Aug. 3, 2006

(54) Graphical medical data acquisition system

(76) Inventors: Scott Cantlin, Perkiomenville, PA (US); Kathleen Evans, Wynnewood, PA (US); Robert Christopher Lukens, New London, PA (US); Mary Dlugos, King of Prussia, PA (US); Daniel Lee, Plymouth Meeting, PA (US); Helen Thomer, Phoenixville, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/180,453

(22) Filed: Jul. 13, 2005

Related U.S. Application Data
(60) Provisional application No. 60/636,738, filed on Dec. 16, 2004.

(51) Int. Cl. G06F 17/30

(52) U.S. Cl. 707/10

(57) ABSTRACT

A graphical documentation system allows clinicians to record information about specific zones of an anatomical image in a fast, intuitive, and easy to understand manner. A graphical user interface system supporting recording of patient medical and other data, includes a display processor for initiating display of data representing a display image. The display image includes, a first area presenting a graphical anatomical image retrieved from a repository, the graphical anatomical image identifies at least one anatomical zone and a second area presents a form associated with a zone selected via user interaction with the identified graphical anatomical image zone. A repository associates a particular form of a particular patient with a corresponding zone identified in the displayed graphical anatomical image. A data processor uses the repository and receives data entered by a user via a displayed form and stores the entered data in a patient medical record of the particular patient.

This is a non-provisional application of provisional application Ser. No. 60/636,738 by S. Cantlin et al. filed Dec. 16, 2004.

### FIELD OF THE INVENTION

This invention concerns a graphical user interface system supporting recording of patient medical and other data for use in patient examination and assessment and associated chart and documentation completion, for example.

### BACKGROUND OF THE INVENTION

Existing medical chart and documentation systems typically involve a manual process for documenting patient medical data whereby a clinician incorporates notations in a paper form associated with a particular anatomical site. In this manual process, the added notations may be difficult to decipher and the meaning and importance or value of the notations may not be consistent between different clinicians or different hospital departments. Further, existing information systems support documentation of patient medical data using medical images (e.g., X-rays, MRIs etc.) but lack adaptability and configurability in the type of images that are accessible and the manner they are incorporated in documentation. The existing information systems also typically do not allow users to define their own images, or import real patient images into documentation. A system according to invention principles addresses these deficiencies and related problems.

### SUMMARY OF INVENTION

A graphical user interface supports user documentation of patient medical data involving a two or three dimensional anatomical image and linking of user selectable image areas to specific adaptable forms enabling incorporation of associated patient medical images. A graphical user interface system supporting recording of patient medical and other data, includes a display processor for initiating display of data representing a display image. The display image includes, a first area presenting a graphical anatomical image retrieved from a repository, the graphical anatomical image identifies at least one anatomical zone and a second area for presenting a form associated with a zone selected via user interaction with the identified graphical anatomical image zone. A repository associates a particular form of a particular patient with a corresponding zone identified in the displayed graphical anatomical image. A data processor uses the repository and receives data entered by a user via a displayed form and stores the entered data in a patient medical record of the particular patient.

### BRIEF DESCRIPTION OF THE DRAWING

FIG. 1 shows a networked hospital information system including a system for graphical documentation of patient medical data, according to invention principles.

FIG. 2 shows a user interface display image illustrating an anatomical representation and an adaptable form associated with a user selected zone in the anatomical image, according to invention principles.

FIG. 3 shows a flowchart of a process supporting documentation of patient medical data, according to invention principles.

### DETAILED DESCRIPTION OF THE INVENTION

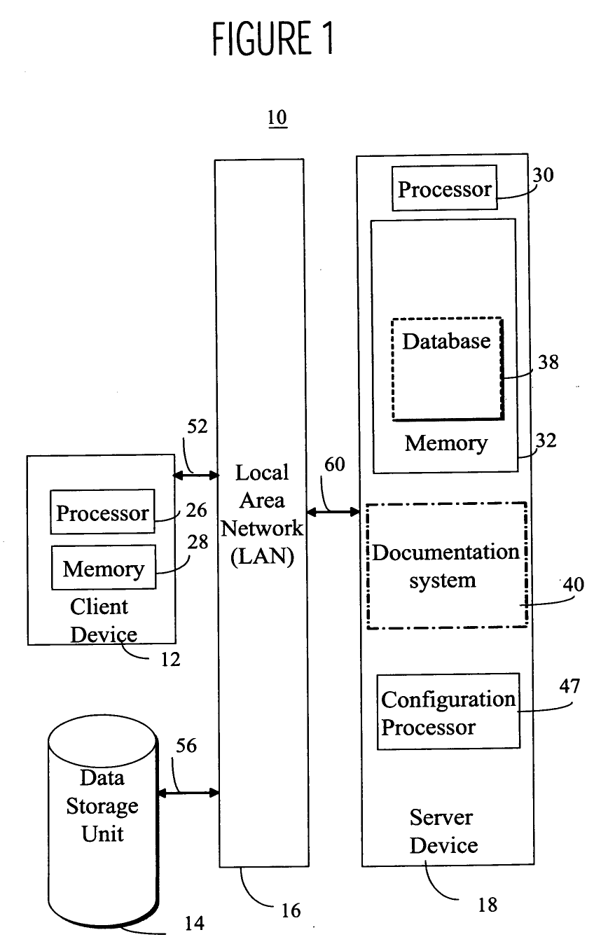

FIG. 1 shows a networked hospital information system including a system for graphical documentation of patient medical data. The graphical documentation system allows clinicians (including physicians and nurses) to document (e.g., chart) clinician made assessments of patient medical condition linked to particular zones of an anatomical image (e.g., an image of the human body). The graphical documentation system and associated menus link image zones to specific adaptable forms. A configuration processor allows hospitals to customize the graphical documentation system by determining selectable available image zones on a displayed anatomical image as well as to select and adapt forms linked to these image zones. A user is also able to create and import patient medical images as well as standard (e.g., textbook or reference medical images). The graphical documentation system provides different ways for a clinician to capture and record patient medical assessment data including patient medical images.

The graphical documentation system enables a user to associate patient medical images to a form. The system also automatically links areas of the displayed anatomical image to other data entry forms. For example, a user is able define a human body, front and back image with a skin assessment form and at runtime, the user may click the right hand on the image to chart information about the right hand. The graphical documentation system also provides a configuration processor for initiating display of a configuration image including a user selectable tab (termed an Adaptable Graphical Charting tab for illustration) to be used to initiate generation of an image window to associate an image to an adaptable form and to link existing forms to zones on a displayed anatomical image. Specifically, the graphical documentation system is employed by a user to associate a particular form with a patient medical image and to specify anatomical zones and link the anatomical zones to adaptable forms. As an illustration, a user links a Foot Observations form to a right foot zone on an anatomical image for a particular patient.

At runtime of an executable application employed by the graphical documentation system, in response to user selection of the right foot zone on the displayed anatomical image, the Foot Observations form is displayed in an image window. The graphical documentation system supports a Graphical Notation function that advantageously provides a clinician with the ability to import digital anatomical images taken of a patient and to write on images to make notations.

An executable application as used herein comprises code or machine readable instruction for implementing predetermined functions including those of an operating system, healthcare information system or other information processing system, for example, in response user command or input. An executable procedure is a segment of code (machine readable instruction), sub-routine, or other distinct section of code or portion of an executable application for performing one or more particular processes and may include performing operations on received input parameters (or in response to received input parameters) and provide resulting output parameters. A processor as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example.

A display processor or generator is a known element comprising electronic circuitry or software or a combination of both for generating display images or portions thereof. A user interface comprises one or more display images enabling user interaction with a processor or other device. A form comprises a template (and data representing a template) including one or more data fields for receiving user entered data, pre-populated data from a system or images (or image representative data) either automatically or in response to user command. A form selector is a processor for automatically selecting a form in response to a predetermined map associating a form and zone, a link between a form and a zone or rules for selecting a form, in response to received data. A data analyzer is a processor for processing data to provide derivative information concerning the data and indicating relationships, statistical significance or other characteristics of the data.

FIG. 1 shows a networked hospital information system including a graphical documentation system 40 of patient medical data. Healthcare information system 10 includes a client device 12, a data storage unit 14, a first local area network (LAN) 16 and a server device 18. The first local area network (LAN) 16 provides a communication network among the client device 12, the data storage unit 14 and the server device 18. The first LAN 16 may be implemented as a wide area network (WAN) e.g., the Internet, for example. Each of the communication paths 52, 56 and 60 are preferably adapted to use one or more data formats, otherwise called protocols, depending on the type and/or configuration of the various elements in the healthcare information systems 10. Examples of the information system data formats include, without limitation, an RS232 protocol, an Ethernet protocol, a Medical Interface Bus (MIB) compatible protocol, DICOM protocol, an Internet Protocol (I.P.) data format, a local area network (LAN) protocol, a wide area network (WAN) protocol, an IEEE bus compatible protocol, and a Health Level Seven (HL7) protocol.

Client device 12 includes processor 26 and memory unit 28 and may comprise a personal computer, for example. The healthcare information system 10 is used by a healthcare provider that is responsible for monitoring the health and/or welfare of people in its care. Examples of healthcare providers include, without limitation, a hospital, a nursing home, an assisted living care arrangement, a home health care arrangement, a hospice arrangement, a critical care arrangement, a health care clinic, a physical therapy clinic, a chiropractic clinic, and a dental office. Examples of the people being serviced by the healthcare provider include, without limitation, a patient, a resident, and a client.

Graphical documentation system 40 supports input of information by a user and display of image menus containing information and receiving user entered information. System 40 may alternatively reside in client device 12 instead of server 18. Client device 12 includes an input device that permits a user to input information and an output device that provides a user a display of menus and other information. The client device 12 input device is a keyboard and mouse, but also may be a touch screen or a microphone with a voice recognition program, or a telephone voice response system for example. The output device is a display, but also may employ a speaker, for example. The output device provides information to the user responsive to the input device receiving information from the user or responsive to other activity by client device 12. For example, the display presents information responsive to the user entering information in the client device 12 via a keyboard.

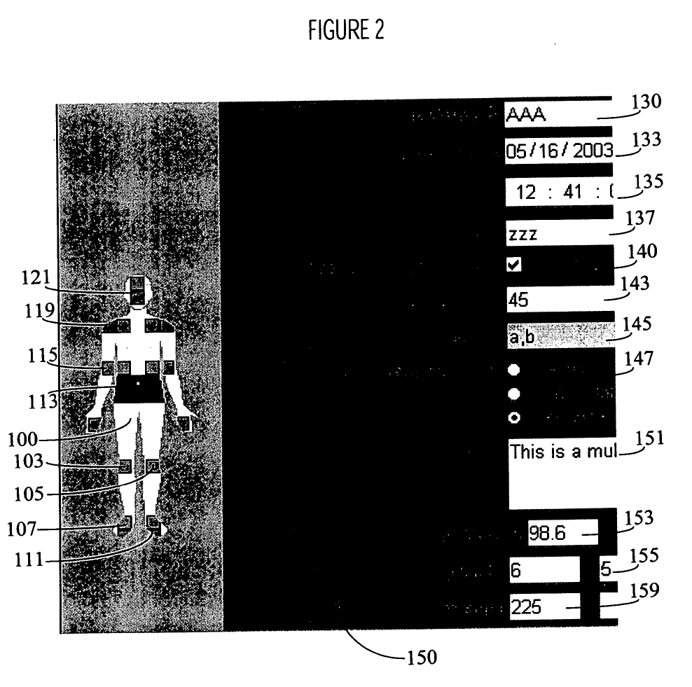

FIG. 2 shows a user interface display image provided by graphical documentation system 40 (FIG. 1) illustrating an anatomical body image representation 100 (FIG. 2) and an adaptable form 150 associated with a user selected zone 113 in the anatomical image. Anatomical image 100 incorporates multiple visible zones including zones 103-121. Although in FIG. 2 anatomical body image representation 100 shows a whole human body, this is for illustrative purposes only. In other modes of operation or other embodiments, image 100 may represent a portion of an anatomy that is either internal or external to a human body. Individual user selectable zones are associated and linked with corresponding adaptable forms by mapping data in a repository in graphical documentation system 40 (FIG. 1). A user is able to configure an adaptable form and associate it with a selected anatomical zone in anatomical body image representation 100 using configuration processor 47. User interface images are generated and displayed on client device 12 by processor 47 to support user configuration of an adaptable form and to associate a configured form with a selected anatomical zone in anatomical image representation 100. The user interface images generated by processor 47 also enable a user to select zone areas that are to be displayed in anatomical body image representation 100.

In response to user selection of a zone in anatomical image representation 100, e.g., zone 113, associated form 150 loads in a form area enabling user data entry (e.g. of patient medical assessment data) and a visual attribute of the selected anatomical zone changes (such as to red) to indicate that it is selected. In another embodiment, a different visual attribute of the zone is changed to identify a selected zone differently from a non-selected zone. A changeable visual attribute may comprise one or more of, (a) highlighting, (b) shading, (c) shape and (d) a text or symbol. In response to user selection of another zone, or in response to a form being saved (whichever happens first), previously selected zone 113 again changes color e.g., from red to yellow (or changes another visual attribute in a different embodiment) to indicate that an assessment has been made of a patient anatomical area or region corresponding to selected zone 113. Thereby, a user is able to quickly determine anatomical zones that have been previously charted and to navigate to those anatomical zones based on the zone color (or other visual attribute).

Documentation system 40 enables a user to quickly navigate to a zone within anatomical image 100 and to select the zone. It further facilitates the beginning of data entry using form 150 in order to document patient medical condition as well as entry of data related to particular patient medical images. A user may also readily modify or create a healthcare worker task sequence (workflow) using configuration processor 47 to adapt either or both, anatomical image 100 or form 150 to meet particular requirements. Form 150 advantageously enables a user to record information about specific patient anatomical zones of image 100 in a fast, intuitive, and easy to understand manner.

Adaptable form 150 comprises a form used by a healthcare worker for making a clinical assessment of patient condition, entry of data concerning a diagnosis or entry of a report by a clinician, for example. Form 150 may contain an image such as an MRI, CT scan, X-ray, ultra-sound, etc. of selected anatomical zone 113 or a link e.g., a hyperlink to an image stored in a remote or local repository. Patient medical images within form 150 may be imported from other data sources (e.g., other healthcare facilities or organizations or a catalog of images created by a hospital) into a record comprising form 150 or may be accessed via links in the record. Form 150 may also contain a diagram of selected anatomical zone 113 or a text book or reference diagram of zone 113. Documentation system 40 automatically acquires patient medical image data from local or remote data sources for incorporation into form 150 without interrupting a task sequence (workflow) of a user and data entry into form 150 by the user in performing a patient assessment. System 40 may alternatively import images in response to user command without interrupting user workflow by requiring a user to select another function. Further, documentation system 40 and associated user interface presented on client device 12 enables a user to annotate a patient medical image incorporated in form 150 with information about the image that is associated with user selected image zone 113.

Documentation system 40 automatically imports images into form 150 concerning image zone 113. The imported images may be obtained over a particular time period and represent progression of medical condition over this period for the particular patient concerned. Documentation system 40 in conjunction with client device 12 facilitates viewing of patient medical images acquired over a time period to support quick comparison of images over this time period and the making of an assessment of change in medical condition over this period to improve healthcare worker ability to track patient progress against a treatment plan. System 40 also supports printing of assessment reports, for example, including form 150 and associated patient medical images via a reproduction device (not shown). System 40 also supports communication of assessment reports, for example, including form 150 via a network to other locations or facilities.

Documentation system 40 supports generation of anatomical zone 113 (and anatomical body image representation 100) that are either two-dimensional or three-dimensional image representations. Documentation system 40 also supports user navigation of form 150 and anatomical image 100 as well as inward and outward zoom capability of anatomical image 113. The zoom capability enables a user to successively enlarge an anatomical region of interest (e.g., zone 113) to see images of increasing anatomical detail. An image representing an enlarged anatomical image zone also contains user selectable image zones that are capable of selection and further expansion via zoom capability. System 40 also provides a zoom out function enabling a user to navigate back through enlarged image zones to zones of less detail. System 40 supports image transformation capabilities including rotation, scaling, and distortion of images. In two-dimensional operation, individual selectable image zones 103-121 have an outline that indicates the size and shape of the anatomical zone. In three-dimensional operation, individual selectable image zones 103-121 have outline contours that indicates the size, shape and volume of the anatomical zone. Further, a name of a particular anatomical zone is displayed (as a tooltip) in response to a user placing a cursor above the particular anatomical zone.

Graphical documentation system 40 initiates display of adaptable form 150 on client device 12 in response to user selection of zone 113 in anatomical body image representation 100. Further, in response to received user identification and clinician identification information, documentation system 40 automatically pre-populates form 150 with information including, clinician identification information, patient identification information and patient medical information, for example, derived from a medical record of a particular patient. Graphical documentation system 40 also enables a user to pre-populate form 150 with data from a previously stored form of a prior patient medical condition assessment, for example. Patient height 155, weight 159 and gender (not shown) are also automatically pre-populated into form 150. Other data elements 130-153 are entered by a user into form 150 to document an assessment of a patient. Element 130 is a text box for user completion. Elements 133 and 135 include data and time respectively of the assessment made using form 150. Elements 137-153 include user entered data identifying patient clinical and other information.

Server device 18 includes processor 30, a memory unit 32 and a database 38 containing patient records. Server device 18 may be implemented as a personal computer or a workstation. Database 38 provides a location for storing patient records and data storage unit 14 provides an alternate store for patient records, as well as other information for hospital information system 10. Patient records in data storage unit 14 or database 38 include information related to a patient including, without limitation, biographical, financial, clinical, workflow, care plan and patient encounter (visit) related information. The information in data storage unit 14 and database 38 are accessed by multiple users from multiple client devices. Graphical documentation system 40 initiates storage of data captured using form 150 in a patient record in database 38 or in a patient record in repository 14. Graphical documentation system (or processor 30) analyzes captured stored patient data (such as assessment information and observations) in database 38 or repository 14 in response to user command. Based on the analysis, processor 30 initiates generation of a medical report concerning captured patient medical assessment data. Processor 30 may also automatically schedule a task to be performed by a healthcare worker or initiate generation of a message for communication to a worker, in response to the analysis.

The use of form 150 for capturing patient data during a medical condition assessment, for example, facilitates consistent assessments using common terminology between different healthcare workers. Form 150 also supports consistent assessment data entry between different healthcare workers for individual image zones. In contrast, current manual assessment methods using paper record entry typically result in substantial variation of data entry and associated terminology between different healthcare workers. This dilutes and reduces the clinical value of the entered information.

In an alternative embodiment, graphical documentation system 40 includes a web browser application used to perform image zone selection and enable capturing notations directly on images within the web browser and also to support printing of image data. System 40 may also be advantageously incorporated into other systems such as a Physician Order Entry workflow system, for example, enabling users to annotate body sites or body systems or functions for a diagnostic or therapeutic order. The system is of particular use for nursing charting and clinical documentation.

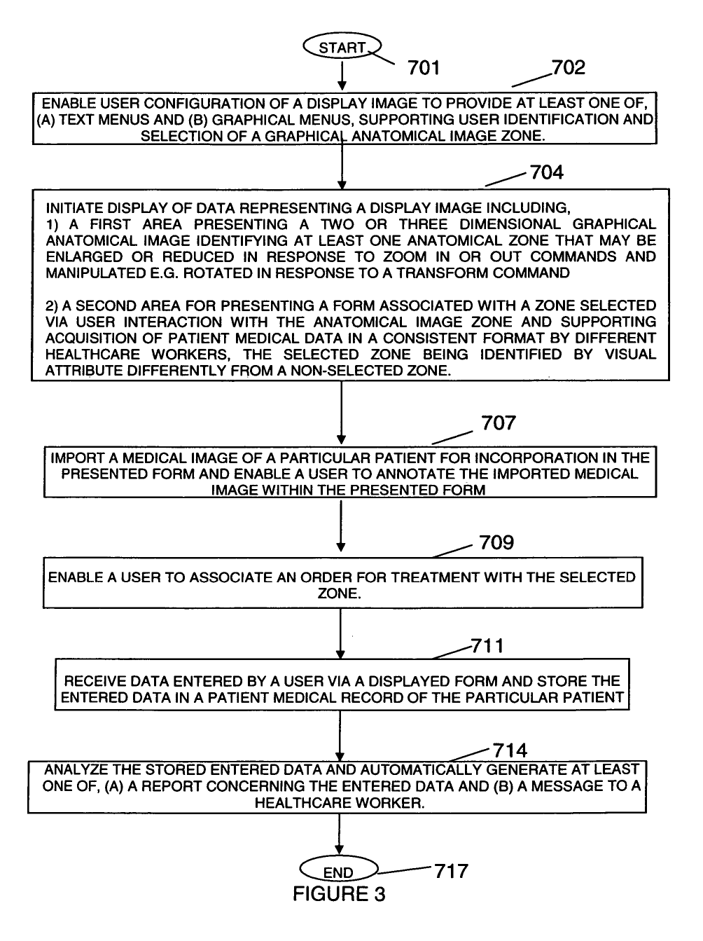

FIG. 3 shows a flowchart of a process employed by graphical documentation system 40 to support documentation of patient medical data. System 40 incorporates (and operates in conjunction with) a web browser application. In step 702 following the start at step 701, system 40 enables user configuration of a display image to provide at least one of, (a) text menus and (b) graphical menus, in the display image supporting user identification and selection of a graphical anatomical image zone. System 40 initiates generation and display of at least one configuration menu for this purpose. In step 704, system 40 initiates display of data representing a display image on client device 12 including, a first area presenting a two or three dimensional graphical anatomical image retrieved from repository 38. The graphical anatomical image identifies at least one anatomical zone. The identified graphical anatomical image zone has an outline approximating anatomical location and shape of an anatomical area concerned. System 40 initiates display of data representing multiple successive display images comprising corresponding successively enlarged or reduced portions of the two or three dimensional graphical anatomical image in response to received user entered zoom in or out commands. The successive display images are associated in repository 38 from which they are accessed. System 40 also supports manipulation such as rotation of an anatomical image zone in response to a transformation command in order to enable a user to view a desired anatomical region and select a graphical anatomical zone.

The display image also includes a second area for presenting a form associated with a zone selected via user interaction with the graphical anatomical image. The selected zone is identified in the first area in the display image by an associated visual attribute differently from a non-selected zone. The visual display attribute includes different first and second visual display attributes associated with the identified graphical anatomical image zone and indicating at least one of, (a) an identified graphical anatomical image zone is selected and (b) data entered by a form associated with the identified graphical anatomical image zone has been stored. The display image attribute comprises one or more of, color, highlighting, shading and shape.

System 40 automatically selects a form from multiple stored forms for presentation in the second area in response to patient specific characteristics including at least one of, (a) age (b) gender and (c) predetermined criteria. The predetermined criteria comprise at least one of, (i) user specialty type, (ii) healthcare department type and (iii) particular nurse station. The form supports acquisition of patient medical data in a consistent format by different healthcare workers. The form also supports acquisition of patient medical data in a consistent format in acquiring patient medical data associated with at least one of, (a) a medical specialty and (b) a hospital department. Repository 38 (FIG. 1) associates multiple graphical anatomical image zones with corresponding forms and with corresponding data entered by a user via the corresponding forms on different occasions and associates a particular form of a particular patient with a corresponding zone identified in the displayed graphical anatomical image.

In step 707, system 40 enables a user to initiate importation of a medical image of a particular patient for incorporation into (and association with) a presented form and enables a user to annotate the imported medical image within the presented form. System 40, in step 709, enables a user to associate an order for treatment with a selected zone and with data entered via a presented form. In step 711, system 40 uses repository 38 and receives data entered by a user via a presented form and stores the entered data and an associated medical image in a patient medical record of a particular patient. System 40 also enables retrieval of the stored entered data from the patient medical record of the particular patient and update of the retrieved data. In addition, system 40 enables user navigation through image displays presenting graphical anatomical images in the first area or within form 150 displayed on client device 12 and corresponding user entered data. System 40 in step 714 analyzes the stored entered data and automatically generates at least one of, (a) a report concerning the entered data and (b) a message to a healthcare worker. The process of FIG. 3 ends at step 717.

The system, process and user interface display image presented herein are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, any of the functions provided by the system and process of FIGS. 1 and 3, may be implemented in hardware, software or a combination of both.

What is claimed is:

1. A graphical interface system supporting recording of patient medical and other data, comprising:
a display processor for initiating display of data representing a display image including,
a first area presenting a graphical anatomical image retrieved from a repository, said graphical anatomical image identifying at least one anatomical zone and
a second area for presenting a form associated with a zone selected via user interaction with said graphical anatomical image;
a repository for associating a particular form of a particular patient with a corresponding zone identified in said displayed graphical anatomical image; and
a data processor for using said repository and receiving data entered by a user via a presented form and storing said entered data in a patient medical record of said particular patient.

2. A system according to claim 1, wherein
said identified graphical anatomical image zone has an outline approximating anatomical location and shape of an anatomical area concerned.

3. A system according to claim 1, wherein
said display image includes a visual display attribute associated with said identified graphical anatomical image zone indicating at least one of, (a) said identified graphical anatomical image zone is selected and (b) data entered by a form associated with said identified graphical anatomical image zone has been stored.

4. A system according to claim 3, wherein
said display image attribute comprises at least one of, (a) color, (b) highlighting, (c) shading and (d) shape.

5. A system according to claim 1, wherein
said display image includes different first and second visual display attributes associated with said identified graphical anatomical image zone respectively indicating,
said identified graphical anatomical image zone is selected and
data entered by a form associated with said identified graphical anatomical image zone has been stored.

6. A system according to claim 1, wherein
said form supports acquisition of patient medical data in a consistent format by different healthcare workers.

7. A system according to claim 6, wherein
said form supports acquisition of patient medical data in a consistent format in acquiring patient medical data associated with at least one of, (a) a medical specialty and (b) a hospital department.

8. A system according to claim 1, including
a data analyzer for analyzing said stored entered data and automatically generating at least one of, (a) a report concerning said entered data and (b) a message to a healthcare worker.

9. A system according to claim 1, wherein
said graphical interface system operates in conjunction with a web browser application.

10. A system according to claim 1, wherein
said data processor enables a user to associate a medical image of said particular patient with said presented form.

11. A system according to claim 10, wherein
said data processor enables storage of said data entered via said presented form and said associated medical image in said patient medical record of said particular patient.

12. A system according to claim 1, wherein
said data processor enables a user to initiate importation of a medical image of said particular patient for incorporation in said presented form and enables a user to annotate said imported medical image within said presented form.

13. A system according to claim 1, including
a form selector for automatically selecting a form from a plurality of stored forms for presentation in said second area in response to patient specific characteristics comprising at least one of, (a) age and (b) gender.

14. A system according to claim 1, wherein
said data processor enables a user to associate an order for treatment with said selected zone.

15. A system according to claim 14, wherein
said data processor enables a user to associate an order for treatment with data entered via said presented form.

16. A system according to claim 1, including
a form selector for automatically selecting a form from a plurality of stored forms for presentation in said second area in response to predetermined criteria comprising at least one of, (i) user specialty type, (ii) healthcare department type and (iii) particular nurse station.

17. A system according to claim 1, wherein
said display processor initiates display of data representing a plurality of successive display images comprising corresponding successively enlarged portions of said graphical anatomical image in response to received user entered zoom commands and including
a repository for associating said plurality of successive display images.

18. A system according to claim 1, wherein
said display image comprises a 3-dimensional graphical anatomical image rotatable in response to user command to enable user viewing and selection of a graphical anatomical image zone.

19. A system according to claim 1, including
a repository associating a plurality of graphical anatomical image zones with corresponding forms and with corresponding data entered by a user via said corresponding forms on different occasions and including
an interface processor for enabling user navigation through image displays presenting said graphical anatomical images and corresponding user entered data.

20. A system according to claim 1, wherein
said data processor enables retrieval of said stored entered data from said patient medical record of said particular patient and update of said retrieved data.

21. A system according to claim 1, including
a configuration processor enabling user configuration of said display image to provide at least one of, (a) text menus and (b) graphical menus, in said display image supporting user identification and selection of a graphical anatomical image zone.

22. A graphical interface system supporting recording of patient medical and other data, comprising:
a display processor for initiating display of data representing a display image including,
a first area presenting a graphical anatomical image retrieved from a repository, said graphical anatomical image identifying at least one anatomical zone and
a second area for presenting a form associated with a zone selected via user interaction with said graphical anatomical image, said form supporting acquisition of patient medical data in a consistent format by different healthcare workers, said selected zone being identified by visual attribute differently from a non-selected zone;
a repository for associating a particular form of a particular patient with a corresponding zone identified in said displayed graphical anatomical image; and
a data processor for using said repository and receiving data entered by a user via a presented form and storing said entered data in a patient medical record of said particular patient.

23. A system according to claim 22, wherein
said data processor enables a user to import a medical image of said particular patient for incorporation in said presented form and enables a user to annotate said imported medical image within said presented form.

24. A method for recording patient medical and other data, comprising the activities of:
initiating display of data representing a display image including,
a first area presenting a graphical anatomical image retrieved from a repository, said graphical anatomical image identifying at least one anatomical zone and
a second area for presenting a form associated with a zone selected via user interaction with said graphical anatomical image;
using a repository for associating a particular form of a particular patient with a corresponding zone identified in said displayed graphical anatomical image; and
receiving data entered by a user via a presented form and storing said entered data in a patient medical record of said particular patient, by using said repository.
